(19) United States
(12) Patent Application Publication
(10) Pub. No.: US 2014/0195555 A1
(43) Pub. Date: Jul. 10, 2014

(54) AUTOMATIC REPORT GENERATION IN A NETWORKED COMPUTING ENVIRONMENT

(71) Applicant: WISDOMAIN INC., Gyeonggi-do (KR)

(72) Inventors: Ilsoo Kim, Gyeonggi-do (KR); Seungho Jung, Gyeonggi-do (KR)

(73) Assignee: WISDOMAIN INC., Gyeonggi-do (KR)

(21) Appl. No.: 13/736,978

(22) Filed: Jan. 9, 2013

(51) Int. Cl. G06F 17/30

(52) U.S. Cl. CPC G06F 17/30011
USPC 707/758

(57) ABSTRACT

An approach for automatically generating reports in a networked computing environment is provided. Specifically, in a typical embodiment, a user will: designate and/or modify a report template; input a set of unique identifiers corresponding to a set of electronic documents (e.g., patent documents); optionally designate a hierarchy of the set of electronic documents; provide a set of input parameters for report content; and optionally provide any manually generated content. Thereafter, the electronic documents will be retrieved from a database or the like. Based on the input parameters, report content and/or report objects will be automatically generated from the electronic documents and populated into a report (using the template) along with the manually generated content provided by the user.

### TECHNICAL FIELD

Aspects of the present invention relate to automatic report generation. Specifically, the present invention relates to generation of reports (e.g., from customizable templates) based on electronic documents such as patent documents or the like in a networked computing environment (e.g., a cloud computing environment).

### BACKGROUND

As business competition has become more global, the capability to view technological trends of a specific industry (or to analyze technological competitiveness) has become highly critical. One manner of determining industry trends and/or competiveness is to view various online references such as patent documents. Specifically, patent documents (e.g., issued patents and/or published patent applications) are good indicators of industry trends and the directions in which competitors are shaping their product lines.

Unfortunately, analyzing sets of patent documents and collating the information into cohesive reports remains a time-consuming and manual process. For example, currently such report generation requires a user to manually review patent documents, generate components, make any manual additions, and then generate a report therefrom. Still yet, should the user desire to see statistical trend data (e.g., filing trends, fields of technology, etc.), the user must compile such information manually.

It is also difficult to change the formats of manually generated reports, regardless of whether the input values for the reports are unchanged. Moreover, if the input values for the report are changed, then the content text of the reports could be changed as well. Such a condition makes it difficult to generate the reports automatically. As such, the process remains manual, time-consuming, and prone to human error.

### SUMMARY

In general, embodiments of the present invention provide an approach for automatically generating reports in a networked computing environment. Specifically, in a typical embodiment, a user will: designate and/or modify a report template; input a set of unique identifiers corresponding to a set of electronic documents (e.g., patent documents); optionally designate a hierarchy of the set of electronic documents (e.g., a taxonomic hierarchy); provide a set of input parameters for report content; and optionally provide any manually generated content. Thereafter, the electronic documents will be retrieved from a database or the like. Based on the input parameters, report content and/or report objects will be automatically generated from the electronic documents and populated into a report (using the template) along with the manually generated content (if) provided by the user. In its generated form, the report may include newly generated trend data (e.g., statistics, graphs, etc.) that is automatically generated based on a content of the various electronic documents. Such trend data may include filing quantities for particular entities over time, technological classifications of filings, etc. Regardless, the cohesive report may then be provided to the user for analysis.

A first aspect of the present invention provides a computer-implemented method for generating reports in a networked computing environment, comprising: receiving a set of unique identifiers, the set of unique identifiers corresponding to a set of electronic documents; receiving a set of input parameters associated with the set of unique identifiers; retrieving the set of electronic documents from at least one computer storage device using the set of unique identifiers; generating a set of report content and a set of report objects from the electronic documents based on the set of input parameters; and generating a report using a previously designated template, the report comprising the set of report content, and the set of report objects.

A second aspect of the present invention provides a system for generating reports in a networked computing environment, comprising: a memory medium comprising instructions; a bus coupled to the memory medium; and a processor coupled to the bus that when executing the instructions causes the system to: receive a set of unique identifiers, the set of unique identifiers corresponding to a set of electronic documents; receive a defined hierarchy among the set of unique identifiers; receive a set of input parameters associated with the set of unique identifiers; receive a set of manually provided content; retrieve the set of electronic documents from at least one computer storage device using the set of unique identifiers; generate a set of report content and a set of report objects from the electronic documents based on the set of input parameters; and generate a report using a previously designated template, the report comprising the set of manually provided content, the set of report content, and the set of report objects.

A third aspect of the present invention provides a computer program product for generating reports in a networked computing environment comprising a computer readable storage media, and program instructions stored on the computer readable storage media, to: receive a set of unique identifiers, the set of unique identifiers corresponding to a set of electronic documents; receive a defined hierarchy among the set of unique identifiers; receive a set of input parameters associated with the set of unique identifiers; receive a set of manually provided content; retrieve the set of electronic documents from at least one computer storage device using the set of unique identifiers; generate a set of report content and a set of report objects from the electronic documents based on the set of input parameters; and generate a report using a previously designated template, the report comprising the set of manually provided content, the set of report content, and the set of report objects.

A fourth aspect of the present invention provides a method for deploying a system for generating reports in a networked computing environment, comprising: deploying a computer infrastructure being operable to: receive a set of unique identifiers, the set of unique identifiers corresponding to a set of electronic documents; receive a set of input parameters associated with the set of unique identifiers; receive a set of manually provided content; retrieve the set of electronic documents from at least one computer storage device using the set of unique identifiers; generate a set of report content and a set of report objects from the electronic documents based on the set of input parameters; and generate a report using a previously designated template, the report comprising the set of manually provided content, the set of report content, and the set of report objects.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts an illustrative report according to an embodiment of the present invention.

FIG. 3 depicts a more detailed system diagram according to an embodiment of the present invention.

FIG. 4 depicts a method flow diagram according to an embodiment of the present invention.

FIG. 5 depicts a method flow diagram according to an embodiment of the present invention.

FIG. 6 depicts a method flow diagram according to an embodiment of the present invention.

FIG. 7 depicts a more detailed diagram of the report of FIG. 2 according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for automatically generating reports in a networked computing environment. Specifically, in a typical embodiment, a user will: designate and/or modify a report template; input a set of unique identifiers corresponding to a set of electronic documents (e.g., patent documents); optionally designate a hierarchy of the set of electronic documents (e.g., a taxonomic hierarchy); provide a set of input parameters for report content; and optionally provide any manually generated content. Thereafter, the electronic documents will be retrieved from a database or the like. Based on the input parameters, report content and/or report objects will be automatically generated from the electronic documents and populated into a report (using the template) along with the manually generated content provided by the user. In its generated form, the report may include newly generated trend data (e.g., statistics, graphs, etc.) that is automatically generated based on a content of the various electronic documents. Such trend data may include filing quantities for particular entities over time, technological classifications of filings, etc. Regardless, the cohesive report may then be provided to the user for analysis.

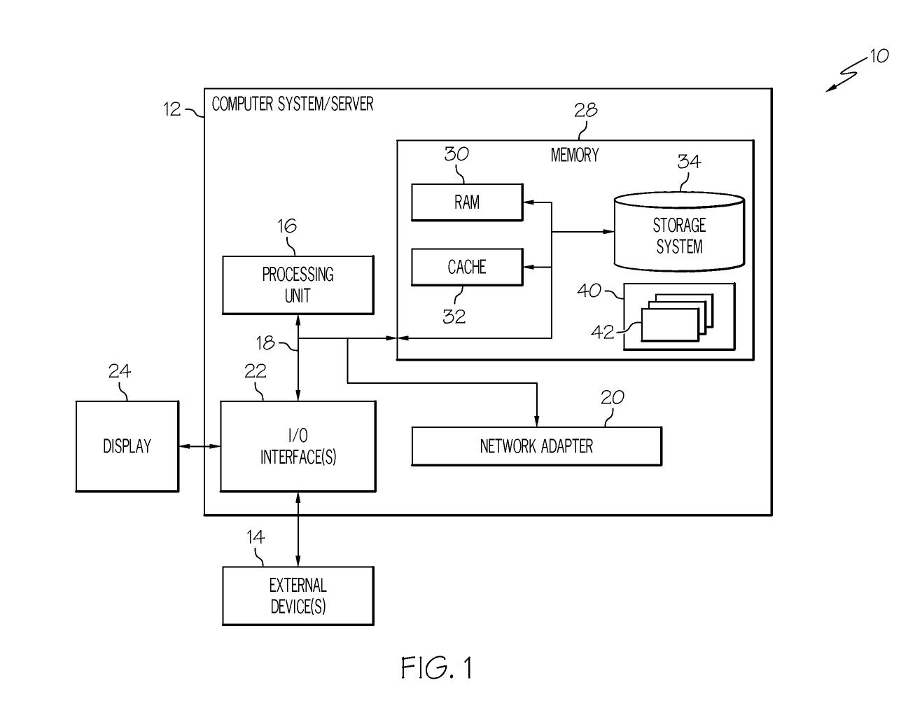

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin potential clients, thick potential clients, hand-held or laptop devices, mobile devices, global positioning systems (GPS), GPS-enabled devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each such media component can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. In general, program/utility 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is understood in advance that although a typical embodiment described herein pertains to the analysis of patent documents, this need not be the case. Rather, similar teachings could be applied to the generation of analysis reports for any type of electronic documents

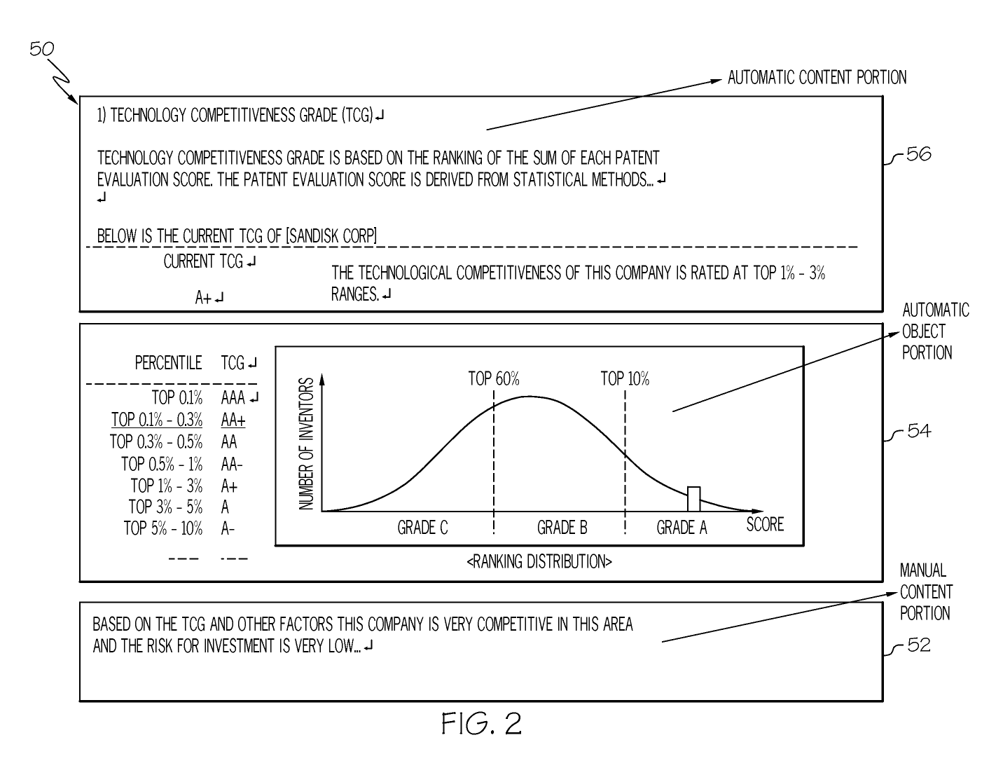

Referring to FIG. 2, a typical analysis report 50 according to an embodiment of the present invention is shown. As depicted, report 50 includes multiple components/portions: manual (e.g., human-generated) content component/portion 52, automatic content component 56, and automatic object component 54. Automatic content portion 56 can include predefined “report content” showing statistical results based on sets of patent data. Automatic object portion 54 can include “report objects” such as graphic charts, tables, indices, etc., showing statistical results based on sets of patent data. Manual content portion 52 can include content manually created by a user and can include any content the user deems necessary. Automatic content portion 56 and automatic object portion 54 are typically generated based on pre-set parameters. Such user-defined parameters can include (among other things) classification names, critical criteria values, type of charts, preset template for report, etc.

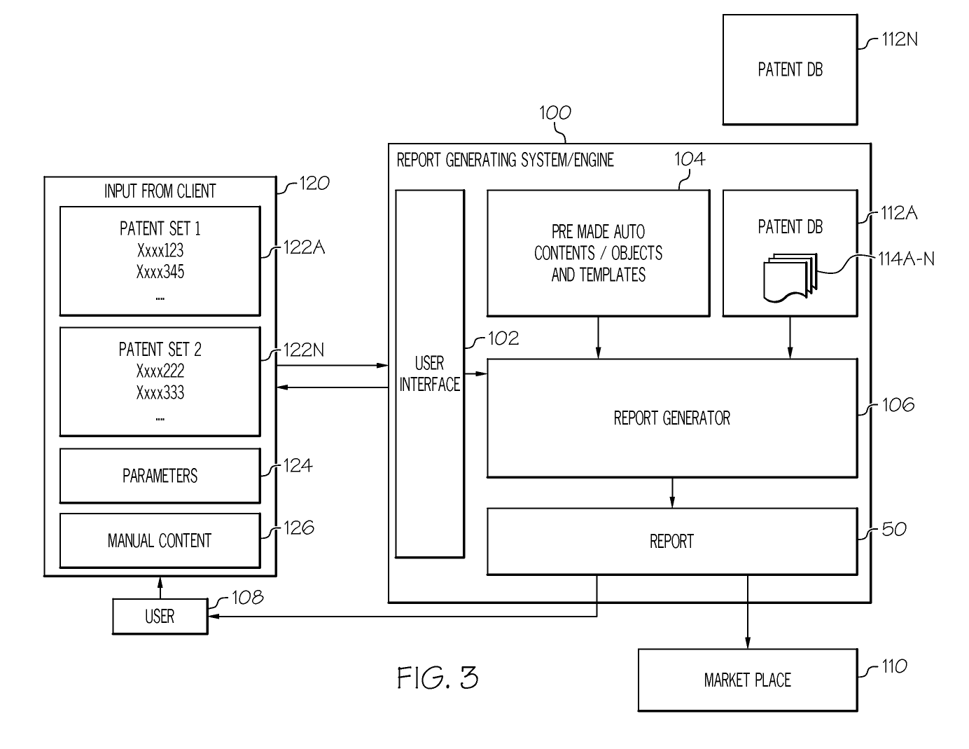

Referring now to FIG. 3, a system diagram describing the functionality discussed herein (and capable of generating a report such as report 50 shown in FIG. 2) according to an embodiment of the present invention is shown. It is understood that the teachings recited herein may be practiced within any type of networked computing environment (e.g., a cloud computing environment). A computer system/server 12 (FIG. 1), which can be implemented as either a stand-alone computer system, or as a networked computer system can be utilized to implement report generating system/engine 100. In the event the teachings recited herein are practiced in a networked computing environment, each potential client need not have an engine 100. Rather, engine 100 could be loaded on a server or server-capable device that communicates (e.g., wirelessly) with the potential clients to report generation functionality hereunder. In general, engine 100 can be implemented as program/utility 40 on computer system/server 12 of FIG. 1 and can enable the functions recited herein. As further shown, engine 100 (in one embodiment) comprises a rules and/or computational engine that processes a set (at least one) of rules/logic and/or provides report generation functionality hereunder.

As depicted, engine 100 typically comprises user interface 102, pre-made resources 104 (e.g., contents, objects, templates, etc.), report generator 106 that produces report 50 for user 108 and/or marketplace 110. As further shown, engine 100 may include or access a document (e.g., patent) database 112A from which electronic documents 114A-N are accessed, analyzed, and processed to yield report 50. As further shown, engine 100 may receive (via user interface 102) various types of user input 120 such as sets of unique identifiers/patent numbers 122A-N, input parameters 124 that designate the type of analysis to be conducted and/or the type of information that should be included in report 50, and manual/human content 126. Each of these user inputs 120 will be used by report generator 106 to: retrieve relevant electronic documents 114A-N from database(s) 112A-N; extract and/or analyze the information in electronic documents 114A-N; automatically generate any report content and/or report objects for report 50; and create report 50 with manual content 126, and automatic report contents/objects 104.

More specifically, engine 100 may perform multiple functions similar to a general-purpose computer. Specifically, among other functions, engine 100 may (among other things); receive a designation of a template (e.g., for possible customization); receive a set of unique identifiers (e.g., patent document numbers), the set of unique identifiers corresponding to a set of electronic documents (e.g., patent documents such as issued patents and/or published patent applications); verify a validity of the set of unique identifiers; recommend a correction for any of the set of unique identifiers determined to be invalid; receive an optionally defined hierarchy (e.g., a taxonomic hierarchy) among the set of unique identifiers; receive a set of input parameters associated with the set of unique identifiers; receive a set of (optional) manually provided content; retrieve the set of electronic documents from at least one computer storage device using the set of unique identifiers; generate a set of report content (e.g., text) and a set of report objects (e.g., graphs) from the electronic documents based on the set of input parameters (e.g., statistical trend content/objects generated based on an analysis of the content of the electronic documents); and/or generate a report using on a previously designated template, the report comprising the set of manually provided content, the set of report content and the set of report objects.

In general, the report will be populated into a template or the like that may be modified (e.g., by the user 108). Such modification may be menu-driven and/or tags-based. Shown below are examples of a tags-based approach:
[human content start] . . . [human content end];
[Automatic content start] autocontent1 with patent set 1 with parameter1:value1, parameter2:value2, parameter3:value3 . . . [Automatic content end]; and
[Automatic object start] autoobject1 with patent set 1 with parameter1:value1, parameter2:value2, parameter3:value3 . . . [Automatic object end].

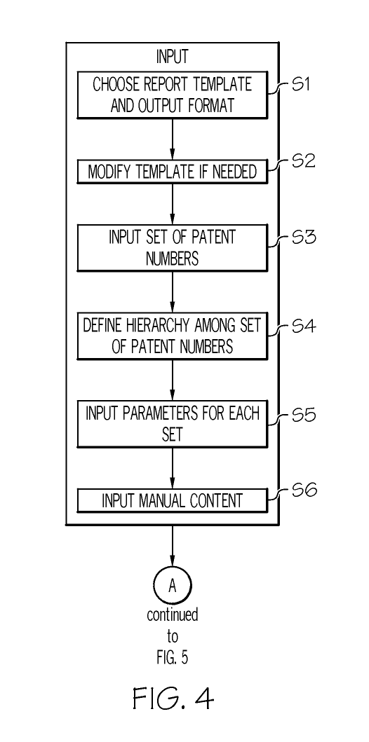

Referring to FIGS. 4-6, method flow diagrams describing the above-functionality are shown. Referring first to FIG. 4, steps involved with providing input used to generate report 50 are shown. As depicted in step 51, a report template and output format is chosen. In step S2, the template may be modified. In step S3, one or more sets of patent numbers/unique identifiers are input. In step S4, a hierarchy may be optionally defined among the set of patent numbers (e.g., to better prioritize the corresponding patent documents in the resulting report). In step S5, input parameters may be input (e.g., for each set of input numbers). In step S6, manual content may be input/provided.

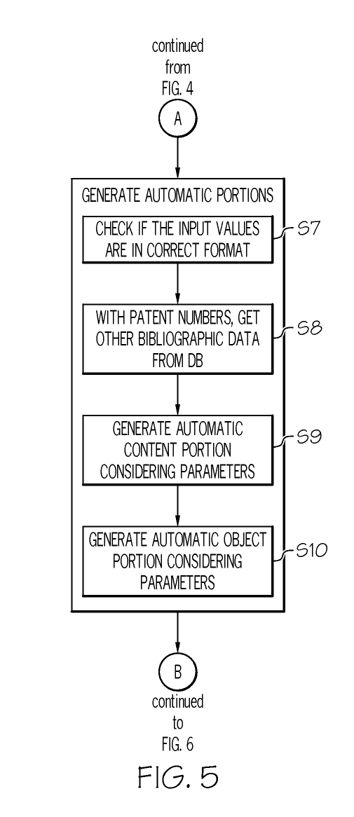

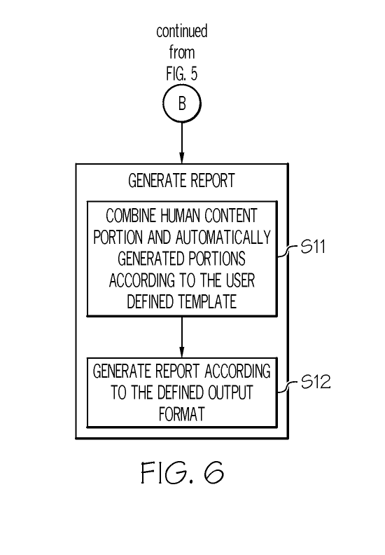

Referring next to FIG. 5, the steps involved with generating automatic portions of the report (e.g., “report content” and/or “report objects”) are shown. In step S7, the input values (e.g., patent numbers/unique identifiers) are checked for accuracy and automatically corrected if in an incorrect format. In step S8, content/bibliographic data is extracted from the corresponding patent documents that are retrieved using the patent numbers/unique identifiers. In steps S9-10, the automatic portions of the report 50 (e.g., automatic object portion 54 and automatic content portion 56) are generated using the input parameters previously provided. Referring to FIG. 6, the final report is generated by adding the manual content portion 52 in step S11, and generating the final report in step S12.

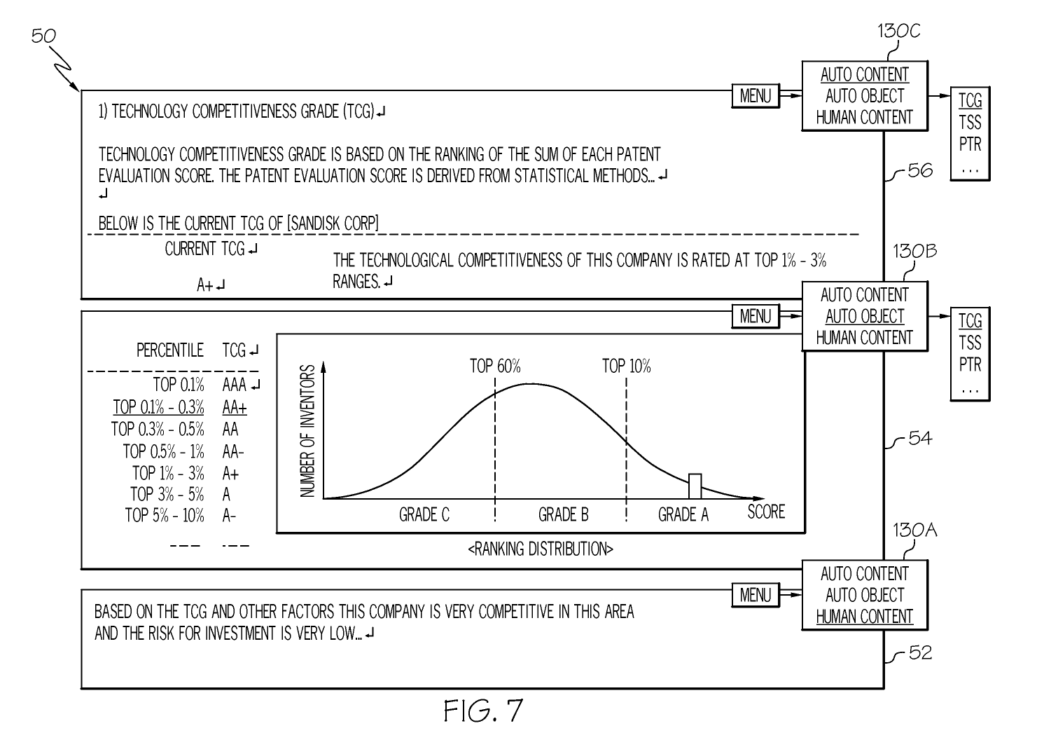

Referring to FIG. 7, it is shown that engine 100 may allow for a report to be toggled showing different types of data. Specifically, as shown, report 50 includes automatic content portion 56 (having “report content”), automatic object portion 54 (having “report objects”), and manual content portion 52 (having “manual/human content”). As further shown, each of these portions may have a menu object 130A-C to select the type of data displayed. In the example shown, a “technology competitiveness grade” type of data is shown in automatic object portions 54 and 56. However, this could be toggled to show other types of data. It is understood that grades and ratings for filing entities or individual electronic documents could be assigned based on predetermined scales. For example, report generator 106 could interpret patent claim scope, specification thoroughness, filing quantities, etc.

While shown and described herein as a report generation solution, it is understood that the invention further provides various alternative embodiments. For example, in one embodiment, the invention provides a computer-readable/useable medium that includes computer program code to enable a computer infrastructure to provide a report generation as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide report generation functionality. In this case, the service provider can create, maintain, support, etc., a computer infrastructure, such as computer system/server 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for a report generation. In this case, a computer infrastructure, such as computer system 12/server (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for generating reports in a networked computing environment, comprising:
receiving a set of unique identifiers, the set of unique identifiers corresponding to a set of electronic documents;
receiving a set of input parameters associated with the set of unique identifiers;
retrieving the set of electronic documents from at least one computer storage device using the set of unique identifiers;
generating a set of report content and a set of report objects from the electronic documents based on the set of input parameters; and
generating a report using a previously designated template, the report comprising the set of report content, and the set of report objects.

2. The computer-implemented method of claim 1, the set of electronic documents comprising a set of patent documents, and the set of unique identifiers identifying the set of patent documents.

3. The computer-implemented method of claim 1, further comprising receiving a defined hierarchy among the set of unique identifiers, the defined hierarchy comprising a taxonomic hierarchy.

4. The computer-implemented method of claim 1, further comprising:
receiving a designation of the template; and
modifying the template to yield a customized template.

5. The computer-implemented method of claim 1, further comprising receiving a set of manually provided content, the report further comprising the set of manually designated content.

6. The computer-implemented method of claim 1, further comprising verifying a validity of the set of unique identifiers.

7. The computer-implemented method of claim 6, further comprising recommending a correction for any of the set of unique identifiers determined to be invalid.

8. A system for generating reports in a networked computing environment, comprising:
a memory medium comprising instructions;
a bus coupled to the memory medium; and
a processor coupled to the bus that when executing the instructions causes the system to:
receive a set of unique identifiers, the set of unique identifiers corresponding to a set of electronic documents;
receive a defined hierarchy among the set of unique identifiers;
receive a set of input parameters associated with the set of unique identifiers;
receive a set of manually provided content;
retrieve the set of electronic documents from at least one computer storage device using the set of unique identifiers;
generate a set of report content and a set of report objects from the electronic documents based on the set of input parameters; and
generate a report using a previously designated template, the report comprising the set of manually provided content, the set of report content, and the set of report objects.

9. The system of claim 8, the set of electronic documents comprising a set of patent documents, and the set of unique identifiers identifying the set of patent documents.

10. The system of claim 9, the set of patent documents comprising at least one of the following: issued patents or published patent applications.

11. The system of claim 8, the memory medium further comprising instructions for causing the system to receive a designation of the template.

12. The system of claim 11, the memory medium further comprising instructions for causing the system to modify the template to yield a customized template.

13. The system of claim 8, the memory medium further comprising instructions for causing the system to verify a validity of the set of unique identifiers.

14. The system of claim 13, the memory medium further comprising instructions for causing the system to recommend a correction for any of the set of unique identifiers determined to be invalid.

15. A computer program product for generating reports in a networked computing environment comprising a computer readable storage media, and program instructions stored on the computer readable storage media, to:
receive a set of unique identifiers, the set of unique identifiers corresponding to a set of electronic documents;
receive a defined hierarchy among the set of unique identifiers;
receive a set of input parameters associated with the set of unique identifiers;
receive a set of manually provided content;
retrieve the set of electronic documents from at least one computer storage device using the set of unique identifiers;
generate a set of report content and a set of report objects from the electronic documents based on the set of input parameters; and
generate a report using a previously designated template, the report comprising the set of manually provided content, the set of report content, and the set of report objects.

16. The computer program product of claim 15, the set of electronic documents comprising a set of patent documents, and the set of unique identifiers identifying the set of patent documents.

17. The computer program product of claim 16, the set of patent documents comprising at least one of the following: issued patents or published patent applications.

18. The computer program product of claim 15, the computer readable storage media further comprising instructions to receive a designation of the template.

19. The computer program product of claim 18, the computer readable storage media further comprising instructions to modify the template to yield a customized template.

20. The computer program product of claim 15, the computer readable storage media further comprising instructions to verify a validity of the set of unique identifiers.

21. The computer program product of claim 20, the memory medium further comprising instructions for causing the system to recommend a correction for any of the set of unique identifiers determined to be invalid.

22. A method for deploying a system for generating reports in a networked computing environment, comprising:
deploying a computer infrastructure being operable to:
receive a set of unique identifiers, the set of unique identifiers corresponding to a set of electronic documents;
receive a set of input parameters associated with the set of unique identifiers;
receive a set of manually provided content;
retrieve the set of electronic documents from at least one computer storage device using the set of unique identifiers;
generate a set of report content and a set of report objects from the electronic documents based on the set of input parameters; and
generate a report using a previously designated template, the report comprising the set of manually provided content, the set of report content, and the set of report objects.
